(19) United States
(12) Patent Application Publication
(10) Pub. No.: US 2014/0123415 A1
(43) Pub. Date: May 8, 2014

(54) CLEANING APPARATUS

(71) Applicant: Sony Corporation, Tokyo (JP)

(72) Inventors: Fujio Kanayama, Kanagawa (JP); Tsuyoshi Ogawa, Kanagawa (JP); Kazuyoshi Yamada, Tokyo (JP); Shuichi Otaki, Kanagawa (JP)

(21) Appl. No.: 14/068,865

(22) Filed: Oct. 31, 2013

(30) Foreign Application Priority Data
Nov. 8, 2012 (JP) 2012-246768

(51) Int. Cl. G02B 6/38

(52) U.S. Cl. CPC G02B 6/3866
USPC 15/97.1

(57) ABSTRACT

A cleaning apparatus includes one set of a supply roll supplying a strip-shaped cleaning sheet and a collection roll collecting the cleaning sheet supplied from the supply roll and a cleaned material is cleaned using a first cleaning surface formed on one surface of one cleaning sheet and a second cleaning surface formed on the other surface.

First to eighth guide rolls are provided to guide the cleaning sheet to make the cleaning sheet pass through one side and the other side of an optical fiber. The first to eighth guide rolls guide the cleaning sheet such that the first cleaning surface of the cleaning sheet positioned at one side and the second cleaning surface of the cleaning sheet positioned at the other side face each other with the optical fiber therebetween.

As a result, the cleaned material can be cleaned using both sides of the cleaning sheet.

### CROSS REFERENCE TO RELATED APPLICATIONS

This application claims the benefit of Japanese Priority Patent Application JP 2012-246768, filed on Nov. 8, 2012, the entire contents of which are incorporated herein by reference.

### TECHNICAL FIELD

The present disclosure relates to a cleaning apparatus and more particularly, to a cleaning apparatus that is suitable for cleaning of a cleaned material such as an optical fiber exposed from an optical fiber cable.

### BACKGROUND ART

In the past, an optical fiber cable in which an optical fiber is coated with a coating material such as a resin has been known. When a connector such as a substrate or a ferrule is mounted to an end of the optical fiber cable, the coating material is removed in advance to expose the optical fiber.

In addition, because scraps of the removed coating material are attached to a surface of the exposed optical fiber, it is necessary to clean the surface of the optical fiber in advance, before the connector is mounted to the optical fiber.

In order to perform this work, an optical fiber cable processing apparatus described in Patent Literature 1 is provided with a cleaning apparatus including supply rolls that supply strip-shaped cleaning sheets, collection rolls that collect the cleaning sheets supplied from the supply rolls, guide rolls that are provided between the supply rolls and the collection rolls and guide the cleaning sheets, and a pair of pressing members that are disposed to face each other with a cleaned material (optical fiber) therebetween and approach each other or are separated from each other.

In the cleaning apparatus, the cleaning sheets are guided by the guide rolls such that the optical fiber is positioned between the cleaning sheets and the pressing members hold the optical fiber with the cleaning sheets, so that the cleaned material is cleaned.

### CITATION LIST

### Patent Literature

PTL 1: JP 3301253

### SUMMARY

### Technical Problem

However, in the cleaning apparatus described in Patent Literature 1, the supply rolls and the collection rolls of two sets are provided and the optical fiber is positioned between the two cleaning sheets guided between the supply rolls and the collection rolls. For this reason, the two cleaning sheets are necessary.

Accordingly, the present disclosure provides a cleaning apparatus that can clean a cleaned material using both sides of the cleaning sheets.

### Solution to Problem

A cleaning apparatus according to an embodiment of the present disclosure includes a supply roll that supplies a strip-shaped cleaning sheet, a collection roll that collects the cleaning sheet supplied from the supply roll, guide rolls that are provided between the supply roll and the collection roll and guide the cleaning sheet, and a pair of pressing members that are disposed to face each other with a cleaned material therebetween and approach each other or are separated from each other, guides the cleaning sheet by the guide rolls such that the cleaned material is positioned between the cleaning sheet and the cleaning sheet, and cleans the cleaned material by allowing the pressing members to hold the cleaned material with the cleaning sheet,

wherein the supply roll and the collection roll of one set are provided and the cleaned material is cleaned using a first cleaning surface formed on one surface of one cleaning sheet and a second cleaning surface formed on the other surface, and
the guide rolls guide the cleaning sheet, such that the first cleaning surface of the cleaning sheet positioned at one side and the second cleaning surface of the cleaning sheet positioned at the other side face each other with the cleaned material therebetween, and make the cleaning sheet pass through one side and the other side of the cleaned material.

### Advantageous Effects of Invention

According to an embodiment of the present disclosure, only the supply roll and the collection roll of one set are provided and the cleaned material can be cleaned by only one cleaning sheet. Therefore, the cleaned material can be cleaned by a small amount of cleaning sheet.

At this time, the first cleaning surface of the cleaning sheet positioned at one side of the cleaned material and the second cleaning surface of the cleaning sheet positioned at the other side are guided by the guide rolls to face the cleaned material.

That is, either the first cleaning surface or the second cleaning surface having passed through the cleaned material once does not pass through the cleaned material again and pollutants attached to the cleaning sheet are not attached to the cleaned material again.

### BRIEF DESCRIPTION OF DRAWINGS

FIG. 1 is a plan view of an optical fiber cable processing apparatus according to this embodiment.

FIG. 2 is a side view of a case and a case holding portion.

FIG. 3 is a cross-sectional view taken along the line III-III of FIG. 2.

FIG. 4 is a front view of the case and (a) illustrates a state in which an optical fiber cable is held in a cable holding portion and (b) illustrates a state in which a work is held in a work holding member.

FIG. 5 is a side view illustrating a drawing station.

FIG. 6 is a side view illustrating a correcting station and (a) illustrates a temporary holding mechanism and (b) illustrates a correcting mechanism.

FIG. 7 is a diagram illustrating a coating material removing station and (a) illustrates a side view and (b) illustrates an enlarged view to describe a coating material removing process.

FIG. 8 is a side view illustrating a cleaning station.

FIG. 9 is a plan view illustrating a cleaning apparatus.

FIG. 10 is a diagram illustrating a cutting station and (a) illustrates a side view and (b) illustrates an enlarged view to describe a cutting process.

FIG. 11 is a diagram illustrating a mounting station and (a) illustrates a position confirmation state of an optical fiber and a work and (b) illustrates a mounting state of the work.

FIG. 12 is a diagram illustrating a returning station and (a) illustrates a station in which the optical fiber cable is returned and (b) illustrates a state in which the work is held by the work holding member.

FIG. 13 is a perspective view illustrating a cleaning apparatus according to a second embodiment.

### DESCRIPTION OF EMBODIMENTS

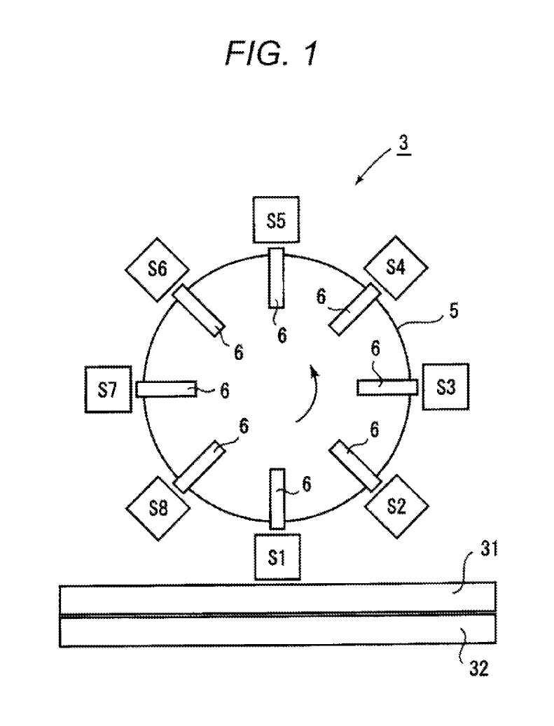

Hereinafter, embodiments will be described with reference to the drawings. FIG. 1 illustrates a plan view of an optical fiber cable processing apparatus 3 including a cleaning apparatus according to the present disclosure that mounts a work 2 to a front end of an optical fiber cable 1.

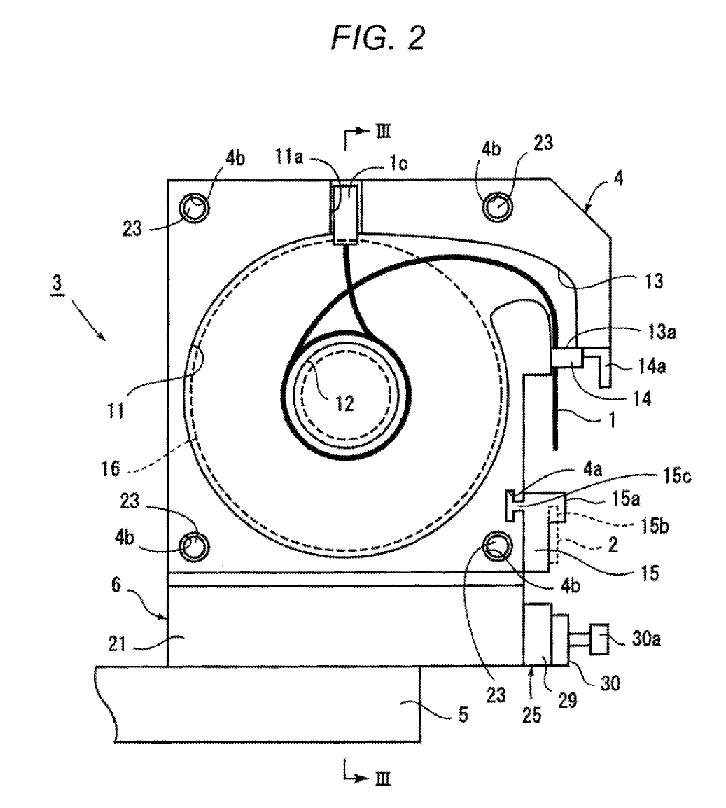

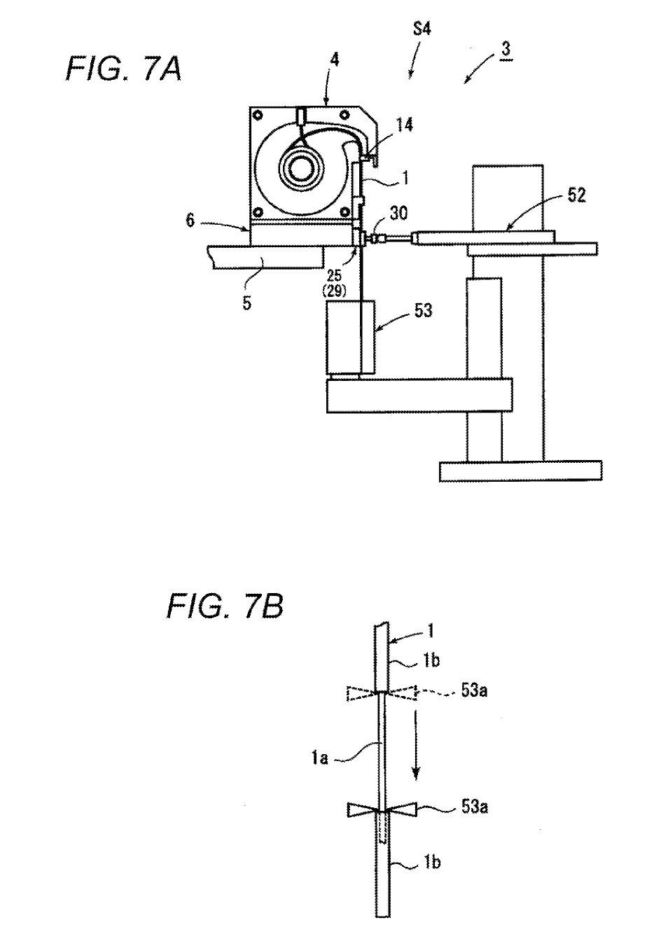

The optical fiber cable 1 has a configuration in which outer circumference of an optical fiber 1a is coated with a coating material 1b made of a thermoplastic resin (refer to FIG. 7(b)). In the optical fiber cable processing apparatus 3, the optical fiber cable 1 is supplied in a state in which the optical fiber cable 1 is wound around an inner portion of a case 4 illustrated in FIG. 2.

A ferrule, a connector, or other electronic substrate corresponds to the work 2. In this embodiment, the work 2 is a flat plate-like electronic substrate with an approximately rectangular shape and the optical fiber 1a is connected to an end of the electronic substrate.

In addition, the optical fiber cable processing apparatus 3 executes a process for removing the coating material 1b of a front end of the optical fiber cable 1 to expose the optical fiber 1a, cutting the exposed optical fiber 1a at a necessary position, and connecting the work 2 to an end of the optical fiber 1a.

In addition, the optical fiber cable processing apparatus 3 includes a rotation table 5 that functions as a conveying mechanism which conveys the case 4 and to which a plurality of work stations S are set along a conveyance path of the case 4, and performs necessary work for the optical fiber cable 1 in each work station S.

In FIG. 1, the rotation table 5 is configured to convey the case 4 in a counterclockwise direction. A

feeding/discharging station S1 to feed/discharge the case 4, a drawing station S2 to draw the optical fiber cable 1 from the case 4, a correcting station S3 to remove a bending peculiarity of the optical fiber cable 1, a coating removing station S4 to remove the coating material 1b of the front end of the optical fiber cable 1, a cleaning station S5 to clean the exposed optical fiber 1a, a cutting station S6 to cut an end face of the optical fiber 1a to be connectable to the work 2, a mounting station S7 to mount the work 2 to the front end of the optical fiber 1a, and a returning station S8 to store the drawn optical fiber cable 1 in the case 4 again are set to the rotation table 5, sequentially from the work station S of a lower end.

The rotation table 5 includes 8 case holding portions 6 of which the number is equal to the number of work stations S1 to S8. The rotation table 5 intermittently rotates with an interval of the case holding portions 6 as one pitch.

The case 4 will be described using FIGS. 2 to 4. The case 4 is formed of a rectangular parallelepiped. A storage space 11 that stores the optical fiber cable 1, a core portion 12 that is provided at the center of the storage space 11 and has the optical fiber cable 1 wound around the core portion, and a guide space 13 that is formed to be adjacent to the storage space 11 and guides the end of the optical fiber cable 1 to the outside are formed in the case 4.

In addition, an opening/closing member 14 that opens/closes a guide entrance 13a and holds the optical fiber cable 1 is provided in a guide entrance 13a of the guide space 13 and a work holding member 15 that stores the work 2 mounted to the front end of the optical fiber 1a is provided below the guide entrance 13a.

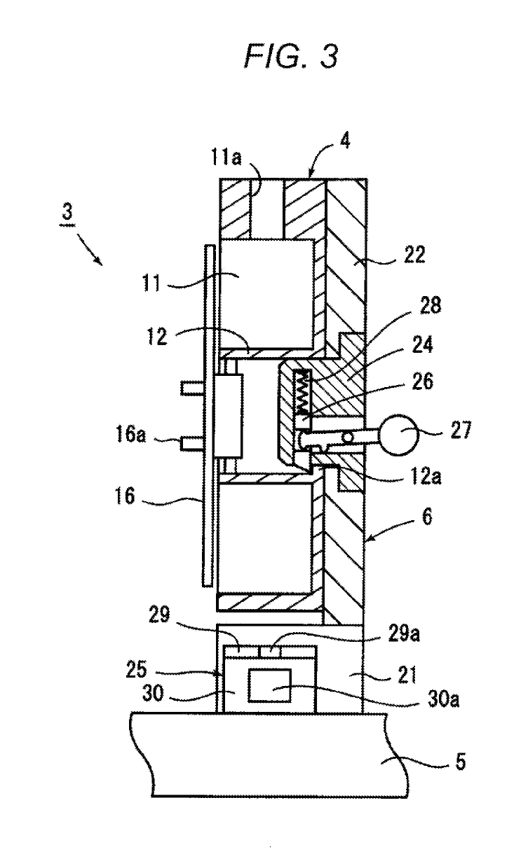

The storage space 11 is formed in an approximately circular shape, the optical fiber cable 1 is stored in the storage space 11 in a state in which the optical fiber cable 1 is wound around the core portion 12, and a left side of the case 4 is opened to the outside as illustrated in FIG. 3.

One end of the optical fiber cable 1 stored in the storage space 11 is guided along the guide space 13 and is drawn to the outside from the guide entrance 13a and the work 2 is mounted to the end of the optical fiber cable 1 exposed to the outside.

In addition, the other end of the optical fiber cable 1 is stored in the storage space 11, a work 1c is mounted to the other end in advance, and the work 1c is inserted into an insertion entrance 11a formed in an upper portion of the storage space 11 from the inner side as illustrated in FIG. 2.

The core portion 12 is formed in a hollow tubular shape and the optical fiber cable 1 is wound around an outer circumferential surface of the core portion 12. As illustrated in FIG. 3, both ends of the core portion 12 are opened to the outside, an inserting portion 24 of the case holding portion 6 to be described below is inserted into a right opening of the core portion 12, and a protrusion 12a engaging with an engagement protrusion 26 protruding from the inserting portion 24 is formed in an inner circumferential surface of the core portion 12.

Meanwhile, a cover material 16 that closes the storage space 11 is mounted to a left opening. By manipulating a lever 16a provided at approximately the center of the cover material 16, the cover material 16 can be attached to or detached from the case 4.

The guide space 13 is formed to be continuous to an upper portion of the storage space 11 as illustrated in FIG. 2, the guide entrance 13a communicating with the outside is formed to face the lower side, and the optical fiber cable 1 is supplied in a state in which the end thereof is pendent from the guide entrance 13a.

The opening/closing member 14 that opens/closes the guide entrance 13a can be switched into a close state in which the opening/closing member 14 contacts an external surface of the case 4 and an open state in which the opening/closing member 14 is separated from the external surface. In the close state, the optical fiber cable 1 is held between the opening/closing member 14 and the external surface of the case 4 to prevent the optical fiber cable 1 from being drawn from the case 4.

A lever 14a that has an approximately L shape is provided at a position adjacent to the opening/closing member 14. By moving the lever 14a in a horizontal direction, the opening/closing member 14 can be switched into the close state or the open state.

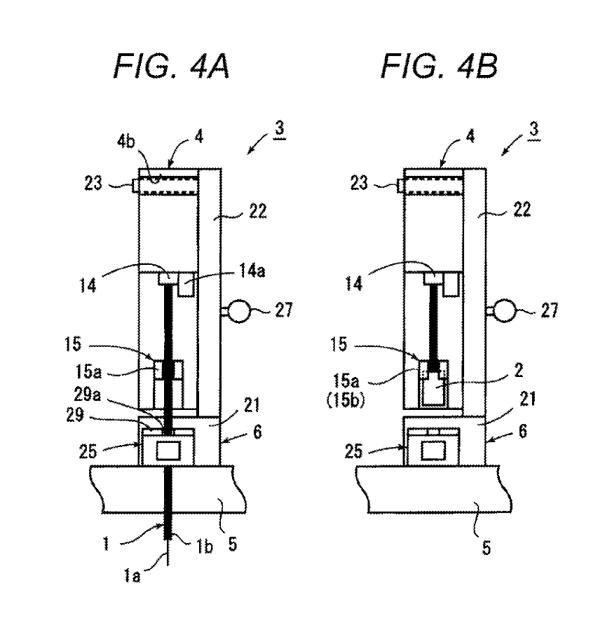

As illustrated in FIGS. 2 and 4, the work holding member 15 is formed to be fixed to an external portion of the case 4, to be positioned at the lower side of the guide entrance 13a in the guide space 13, and to hold the work 2 at a position on an extension line of the optical fiber cable 1 pendent from the guide space 13.

Two protrusions 15a are formed in an end of the side of the guide entrance 13a in the work holding member 15 and the optical fiber cable 1 passes through a space between the protrusions 15a.

In addition, a recess portion 15b formed in a direction opposite to the guide entrance 13a and storing a part of the work 2 is formed in the protrusion 15a and the end of the plate-like work 2 is stored in the recess portion 15b.

By this configuration, when the work 2 mounted to the optical fiber cable 1 is held by the work holding member 15, if the opening/closing member 14 is switched into the close state in a state in which the end of the work 2 is stored in the recess portion 15b, the work 2 can be prevented from being disengaged from the work holding member 15.

Furthermore, the work holding member 15 and the case 4 are configured such that a T-shaped protrusion 15c formed in the work holding member 15 and a T-shaped recess portion 4a formed in the case 4 are fitted with each other. If the work holding member 15 is moved in a depth direction of FIG. 2, the work holding member 15 can be easily attached to or detached from the case 4.

For this reason, when the kind of the work 2 mounted to the optical fiber cable 1 is changed, the work holding member 15 can be changed to other work holding member 15 corresponding to the work holding member 15.

Next, the case holding portion 6 holding the case 4 will be described. The case holding portion 6 includes a base member 21 that is provided at an equivalent interval in the rotation table 5, a plate-like sidewall 22 that is erected upward from the base member 21, four support rods 23 that protrude from the sidewall 22, an inserting portion 24 having an approximately columnar shape that protrudes from the sidewall 22 and is inserted into the core portion 12 of the case 4, and a cable holding mechanism 25 that is provided in the base member 21 and holds the optical fiber cable 1 in the case holding portion 6.

As illustrated in FIG. 3, a gap is formed between a top surface of the base member 21 and a bottom surface of the case 4 and the sidewall 22 adheres closely to a right side of the case 4.

In addition, the support rods 23 are inserted into through-holes 4b formed in four corners of the case 4 as illustrated in FIGS. 2 and 4 and prevent rotation of the case 4 and perform positioning of the case 4.

The inserting portion 24 becomes a cylindrical member that protrudes to the side of the case 4 and is inserted into the core portion 12, a tapered shape is formed in a front end of the inserting portion 24, and an engagement protrusion 26 protruding from an inner portion of the inserting portion 24 to the side of an outer circumferential surface and a lever 27 to manipulate the engagement protrusion 26 are provided in the inserting portion 24.

The engagement protrusion 26 is biased by a spring 28 loaded to an inner portion of the inserting portion 24 to protrude to the outside. If the case 4 moves from the left side of FIG. 3 for the case holding portion 6, the engagement protrusion 26 gets over the protrusion 12a of the core portion 12 and the protrusions engage with each other. Thereby, the case 4 is held in the case holding portion 6 not to be disengaged.

The lever 27 is swingly supported to an inner portion of the inserting portion 24 and one end thereof protrudes to the side opposite to the case 4 in the sidewall 22 from an end of the inserting portion 24.

In addition, if the lever 27 is manipulated, the other end of the lever 27 retracts the engagement protrusion 26 into the inserting portion 24 against the biasing force of the spring 28. As a result, an engagement state with the protrusion 12a of the core portion 12 is released and the case 4 can be separated from the case holding portion 6.

The cable holding mechanism 25 includes a base portion 29 that is provided in the base member 21 and a cover 30 that is provided to be attachable/detachable with respect to the base portion 29 by means of the magnetic force of a magnet not illustrated in the drawings.

A groove 29a into which the optical fiber cable 1 is fitted in a vertical direction is formed in the base portion 29. The optical fiber cable 1 is positioned at the front of the base portion 29 in a state in which the cover 30 is separated from the base portion 29. In this state, the cover 30 is connected to the base portion 29 by means of the magnetic force of the magnet.

In this case, the optical fiber cable 1 is pressed by the cover 30 and moves to the center of the groove 29a of the base portion 29. Then, the optical fiber cable 1 is held not to move during the conveyance by the rotation table 5.

As such, the cable holding mechanism 25 is provided in the base member 21 fixed to the rotation table 5, so that the optical fiber cable 1 can be handled on the basis of a relative position with the cable holding mechanism 25 in each work station S, when the rotation table 5 stops each case 4 in each work station S.

Hereinafter, each work station S will be described. First, the feeding/discharging station S1 will be described. As illustrated in FIG. 1, a supply conveyer 31 and a discharge conveyer 32 that are provided in parallel are provided at positions adjacent to the rotation table 5. The supply conveyer 31 and the discharge conveyer 32 convey the case 4 from the left side to the right side of FIG. 1.

In addition, a transferring mechanism not illustrated in the drawings such as a robot hand is provided in the feeding/discharging station S1. The transferring mechanism holds the case 4 conveyed by the supply conveyer 31 and mounts the case 4 to the case holding portion 6 of the rotation table 5 positioned at the feeding/discharging station S1.

At this time, the transferring mechanism moves the case 4 in a horizontal direction along the support rod 23 of the case holding portion 6, the side of the case 4 contacts the sidewall 22, and the engagement protrusion 26 of the inserting portion 24 engages with the protrusion 12a of the core portion 12 of the case 4. As a result, the case 4 is positioned at the case holding portion 6 and is held not to be disengaged.

Meanwhile, in the feeding/discharging station S1, if the process in the returning station S8 is terminated and the case 4 is conveyed to the feeding/discharging station S1 by the rotation table 5, the transferring mechanism separates the case 4 from the case holding portion 6 and places the case 4 on the discharge conveyer 32.

At this time, a lever manipulating mechanism not illustrated in the drawings manipulates the lever 27 of the case holding portion 6 to retract the engagement protrusion 26 into the inserting portion 24 and release an engagement state with the protrusion 12a of the core portion 12. In this state, the transferring mechanism separates the case 4 from the case holding portion 6 and transfers the case 4 to the discharge conveyer 32.

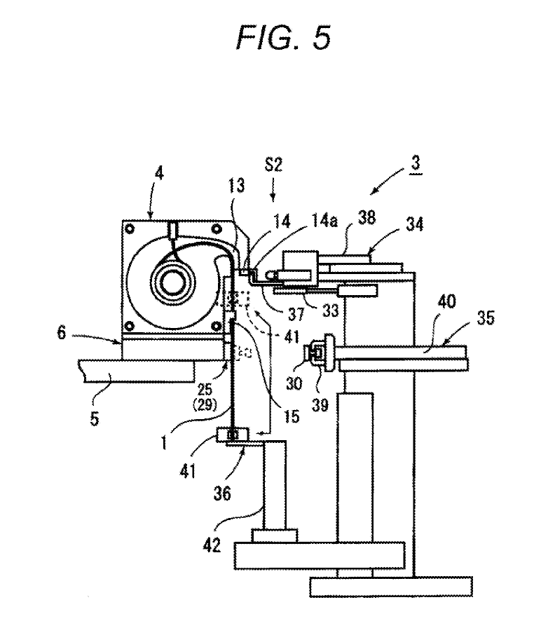

FIG. 5 is a diagram illustrating the drawing station S2. In the drawing station S2, a process for drawing the optical fiber cable 1 from the case 4 and holding the front end thereof by the cable holding mechanism 25 of the case holding portion 6 is executed.

In the drawing station S2, a sensor 33 that detects the optical fiber cable, an opening/closing member moving mechanism 34 that switches the opening/closing member 14 of the case 4 into an open state, a cover attaching/detaching mechanism 35 that attaches/detaches the cover 30 of the cable holding mechanism 25, and a drawing mechanism 36 that draws the optical fiber cable 1 from the case 4 by a predetermined length are provided.

The sensor 33 detects the optical fiber cable 1 that is pendent from the guide entrance 13a of the case 4 conveyed by the rotation table 5. When the sensor 33 may not detect the optical fiber cable 1, a control mechanism determines the case 4 as a defective product and omits work in each work station of the downstream side.

The opening/closing member moving mechanism 34 includes a hook 37 that engages with the lever 14a of the opening/closing member 14 of the case 4 and an air cylinder 38 that reciprocates the hook 37 in a horizontal direction.

The hook 37 is on standby at the inner circumferential side of the rotation table 5 more than the lever 14a by the air cylinder 38 in advance. If the case 4 arrives at the drawing station, the air cylinder 38 moves the hook 37 to the outer circumferential side of the rotation table 5. Thereby, the opening/closing member 14 is switched from a close state to an open state and the optical fiber cable 1 can be drawn.

The cover attaching/detaching mechanism 35 includes a gripper 39 that grips a knob 30a of the cover 30 and an air cylinder 40 that moves the gripper 39 in the horizontal direction. If the air cylinder 40 moves the gripper 39 having gripped the knob 30a, the cover 30 is separated against the magnetic force of the magnet provided between the base portion 29 and the cover 30.

The drawing mechanism 36 includes a gripper 41 that grips the optical fiber cable 1 and a moving mechanism 42 that moves the gripper 41.

First, the gripper 41 that is moved by the moving mechanism 42 grips the optical fiber cable 1 pendent from the guide entrance 13a of the case 4. At this time, the position of the optical fiber cable 1 may be recognized by a camera not illustrated in the drawings.

Next, the opening/closing member moving mechanism 34 switches the opening/closing member 14 of the case 4 into an open state to enable the optical fiber cable 1 to be drawn and the cover attaching/detaching mechanism 35 separates the cover 30 from the base portion 29.

In this case, the moving mechanism 42 moves the front end of the optical fiber cable 1 to avoid the work holding member 15 and the base portion 29 positioned at the lower side of the guide entrance 13a and moves the optical fiber cable 1 to the lower side of the base portion 29.

Thereby, the optical fiber cable 1 is positioned at the front of the base portion 29. In this state, the cover attaching/detaching mechanism 35 mounts the cover 30 to the base portion 29, so that the optical fiber cable 1 is held between the base portion 29 and the cover 30 by means of the magnetic force of the magnet.

As such, in the drawing station S2, the optical fiber cable 1 is drawn from the case 4 and the optical fiber cable 1 is held by the cable holding mechanism 25 provided in the rotation table 5.

Thereby, in each work station S positioned at the downstream side of the drawing station S1, a process can be executed with respect to the optical fiber cable 1 held in the cable holding mechanism 25.

That is, in each work station S, the position of the optical fiber cable 1 can be recognized on the basis of the position of the cable holding mechanism 25. Therefore, a camera or a sensor to detect the front end of the optical fiber cable 1 becomes unnecessary in each work station S.

Furthermore, in each work station S, work for drawing the optical fiber cable 1 from the case 4 and returning the optical fiber cable 1 after the process is terminated becomes unnecessary, it is not necessary to provide the drawing and returning mechanisms in each work station, and a tact time in each work station can be shortened.

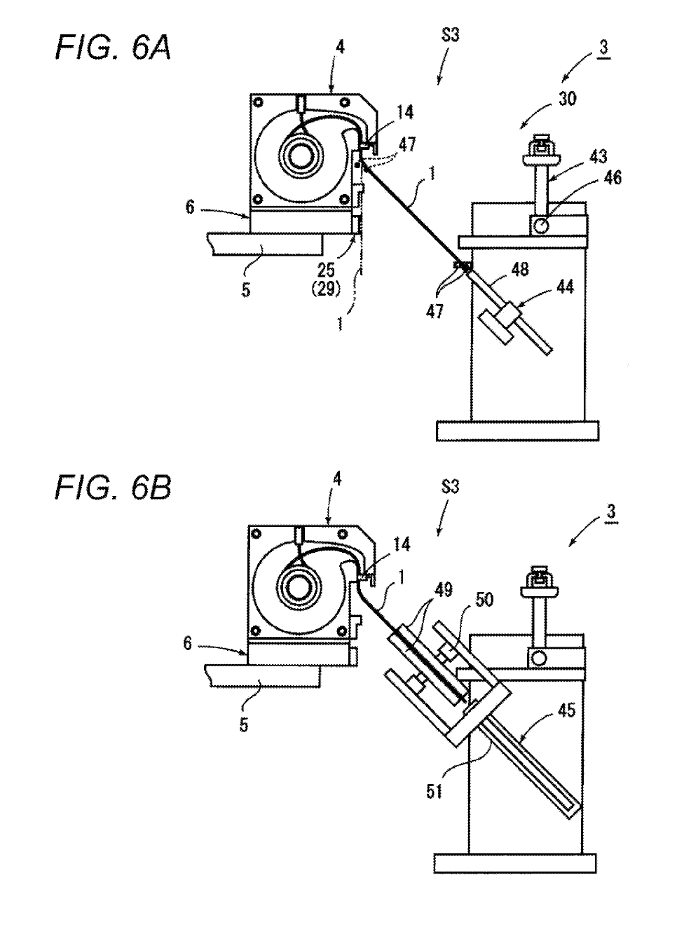

FIG. 6 is a diagram illustrating the correcting station S3. In the correcting station S3, a process for removing a bending peculiarity of the optical fiber cable 1 drawn from the case 4 is executed.

In the case 4 supplied to the optical fiber cable processing apparatus 3, because the optical fiber cable 1 is wound around the core portion 12, the so-called bending peculiarity is generated in the optical fiber cable 1 and the front end pendent on the outside of the case 4 does not have a linear shape and has an irregular shape.

If the bending peculiarity is generated, it becomes difficult to move the front end of the optical fiber 1a and the work 2 relatively and connect the front end of the optical fiber 1a and the work 2. For this reason, in the correcting station S3, the bending peculiarity of the optical fiber cable 1 is corrected in advance.

In addition, the correcting station S3 includes a cover attaching/detaching mechanism 43 that attaches/detaches the cover 30 of the cable holding mechanism 25, a temporary holding mechanism 44 that temporarily holds the optical fiber cable 1 obliquely (FIG. 6(a)), and a correcting mechanism 45 (FIG. 6(b)) that corrects the bending peculiarity of the optical fiber cable 1 drawn from the case 4.

Since the cover attaching/detaching mechanism 43 has the same configuration as the cover attaching/detaching mechanism 35 provided in the drawing station S2, detailed explanation thereof is omitted. However, the cover 30 is retracted by a swinging mechanism 46 to prevent interference with the optical fiber cable 1 held by the temporary holding mechanism 44 and the correcting mechanism 45.

The temporary holding mechanism 44 is provided at the obliquely downward side of the case holding portion 6 and includes two guide bars 47 and a moving mechanism 48 to move the guide bars 47. The moving mechanism 48 moves the guide bars 47 in an oblique direction and a depth direction of FIG. 6.

First, if the case 4 is positioned at the correction station S3 and the cover attaching/detaching mechanism 43 separates the cover 30, the moving mechanism 48 positions the guide bars 47 at the lower side of the guide entrance 13a in the case 4 and positions the optical fiber cable 1 between the two guide bars 47.

In this case, the moving mechanism 48 moves the guide bars 47 to the obliquely downward side. Thereby, the optical fiber cable 1 is guided to the guide bars 47 and is temporarily held obliquely as illustrated in FIG. 6(a). At this time, because the guide entrance 13a of the case 4 is switched into a close state by the opening/closing member 14, the optical fiber cable 1 is not drawn from the case 4.

The correcting mechanism 45 includes two plates 49 that holds the optical fiber cable 1, a heater not illustrated in the drawings that heats the plates 49, and an opening/closing mechanism 50 that includes an air cylinder to make the plates 49 approach each other or the plates 49 separated from each other.

The two plates 49 are provided to be oblique in parallel to the optical fiber cable 1 temporarily held obliquely by the temporary holding mechanism 44 and can be moved by a moving mechanism 51 to move these plates 49.

Although not illustrated in the drawings, a linear groove is formed in the plate 49 positioned at the lower side in the drawings and a protrusion fitted into the groove is formed in the plate 49 positioned at the upper side in the drawings. The plates 49 have the length to hold at least a surrounding portion of a cut portion in the optical fiber cable 1.

In addition, if the moving mechanism 51 positions the plate 49 of the lower side in the drawings at the lower side of the optical fiber cable 1 held by the temporary holding mechanism 44, the opening/closing mechanism 50 makes the two plates approach each other to hold the optical fiber cable 1 and holds the optical fiber cable 1 by the groove and the protrusion to deform the optical fiber cable 1 linearly.

In this state, if the heater heats the plates 49, because the coating material 1b of the optical fiber cable 1 is made of a thermoplastic resin, a state of the optical fiber cable 1 is maintained at the linear state according to the shapes of the groove and the protrusion and the bending peculiarity is removed.

In this way, if the bending peculiarity is corrected, the plates 49 open the optical fiber cable 1 by the opening/closing mechanism 50 and retract the optical fiber cable 1 by the moving mechanism 51. Thereby, the optical fiber cable 1 is pendent straightly toward the lower side by the self weight.

The pendent optical fiber cable 1 is positioned at the front of the base portion 29 in the cable holding mechanism 25 and the cover attaching/detaching mechanism 43 mounts the cover 30 to the base portion 29, so that the optical fiber cable 1 is held in the cable holding mechanism 25 again.

Then, the rotation table 5 can convey the optical fiber cable 1 of which the bending peculiarity has been corrected by the correcting mechanism 45, to each work station S of the downstream side.

FIG. 7 is a diagram illustrating the coating removing station S4. In the coating removing station S4, a process for removing the coating material 1b from the front end of the optical fiber cable 1 and exposing the optical fiber 1a is executed.

In the coating removing station S4, a pressing mechanism 52 that presses the cover 30 of the cable holding mechanism 25 and a coating removing mechanism 53 that removes the coating material 1b from the front end of the optical fiber cable 1 are provided.

The pressing mechanism 52 is configured to press the cover 30 of the cable holding mechanism 25 from the outside. The pressing mechanism 52 holds the optical fiber cable 1 not to be too much drawn from the case 4, even though the optical fiber cable 1 is pulled by the coating removing mechanism 53.

Since the coating removing mechanism 53 is known in the related art, detailed explanation thereof is omitted. However, as illustrated in FIG. 7(b), the coating removing mechanism 53 includes a cutter 53a that moves along an outer circumferential surface of the optical fiber cable 1 and cuts only the coating material 1b and an elevating mechanism not illustrated in the drawings that elevates the cutter 53a and shifts the cut coating material 1b to the lower side along the optical fiber 1a.

In addition, in the coating removing mechanism 53 according to this embodiment, the cut coating material 1b is shifted to the lower side by the predetermined distance along the optical fiber 1a to make the coating material 1b remain at the front end of the optical fiber 1a and the optical fiber 1a is exposed between the separated coating materials 1b.

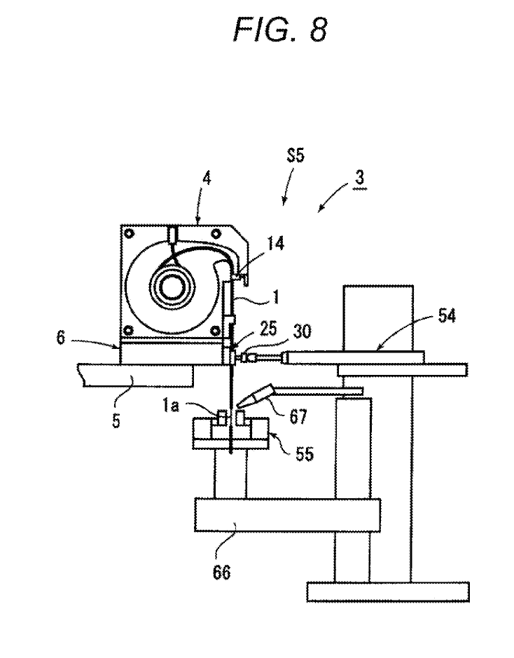

FIG. 8 is a diagram illustrating the cleaning station S5. In the cleaning station S5, a process for removing scraps of a coating resin attached to the exposed optical fiber 1a and cleaning an outer circumferential surface of the optical fiber 1a is executed.

In the cleaning station S5, a pressing mechanism 54 that presses the cover 30 of the cable holding mechanism 25 and a cleaning apparatus 55 according to the present disclosure that cleans the exposed optical fiber 1a are provided.

Similar to the coating removing station S4, the pressing mechanism 54 presses the cover 30 while the optical fiber 1a is cleaned by the cleaning apparatus 55 and holds the optical fiber cable 1 not to be too much drawn from the case 4.

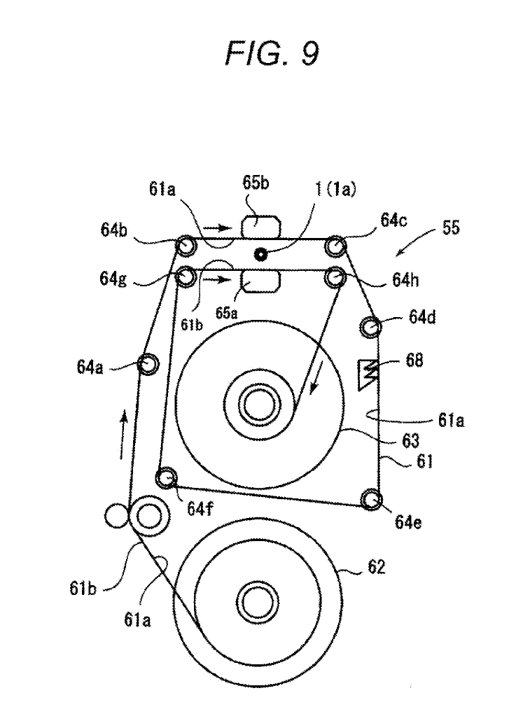

As illustrated in FIG. 9, the cleaning apparatus 55 includes a supply roll 62 that supplies a strip-shaped cleaning sheet 61, a collection roll 63 that winds the cleaning sheet 61, a plurality of guide rolls 64a to 64h that are provided between the supply roll 62 and the collection roll 63 and are provided on a path of the cleaning sheet 61, and a pair of pressing members 65a and 65b that are disposed to face each other to hold the optical fiber 1a and approach each other or are separated from each other. The cleaning apparatus 55 is elevated by an elevating mechanism 66 (refer to FIG. 8).

In addition, a spraying nozzle 67 (refer to FIG. 8) that sprays a cleaning liquid such as alcohol into the cleaning sheet 61 positioned between the pressing members 65a and 65b is provided at a position adjacent to the cleaning apparatus 55.

The cleaning sheet 61 is made of nonwoven fabric and cleans the optical fiber 1a using a first cleaning surface 61a and a second cleaning surface 61b formed on both sides thereof. In FIG. 9, a surface facing the center side of the supply roll 62 is set as the first cleaning surface 61a and a surface facing the outer circumferential side thereof is set as the second cleaning surface 61b.

Only the supply roll 62 and the collection roll 63 of one set are provided. In this embodiment, the optical fiber 1a can be cleaned by only one cleaning sheet 61 provided between the supply roll 62 and the collection roll 63.

Specifically, the supply roll 62 is provided at the side opposite to the pressing member 65b with the collection roll 63 therebetween and the cleaning sheet 61 supplied from the supply roll 62 is guided by the guide rolls 64a to 64c and passes through a space between the pressing member 65b and the optical fiber 1a. Thereby, the first cleaning surface 61a of the cleaning sheet 61 faces the side of the optical fiber 1a.

In this way, the cleaning sheet 61 that has passed through the pressing member 65b is guided by the guide rolls 64c to 64h to enclose the outer circumference of the collection roll 63 and passes through a space between the pressing member 65a and the optical fiber 1a. Thereby, the second cleaning surface 61b of the cleaning sheet 61 faces the side of the optical fiber 1a.

That is, the cleaning sheet 61 is guided by the guide rolls 64a to 64h, so that the cleaning sheet 61 passes through the space between the pressing members 65a and 65b and passes through one side and the other side of the optical fiber 1a. At this time, the first cleaning surface 61a and the second cleaning surface 61b face each other with the optical fiber 1a therebetween.

The pressing members 65a and 65b are configured to approach each other or to be separated from each other by a moving mechanism not illustrated in the drawings. If the optical fiber 1a is positioned between the pressing members 65a and 65b, the pressing members 65a and 65b approach each other and hold the optical fiber 1a with the cleaning sheet 61.

Furthermore, a scraper 68 functioning as a removing mechanism that removes extraneous matter attached to the first cleaning surface 61a is provided between a position where the first cleaning surface 61a passes through one side of the optical fiber 1a and a position where the second cleaning surface 61b passes through the other side of the optical fiber 1a, on the path of the cleaning sheet 61.

When one side of the optical fiber 1a is cleaned by the first cleaning surface 61a of the cleaning sheet 61, the extraneous matter that is attached to the optical fiber 1a is attached to the first cleaning surface 61a. However, the scraper 68 scraps the extraneous matter attached to the first cleaning surface 61a.

As a result, when the cleaning sheet 61 is fed and the other side of the optical fiber 1a is cleaned by the second cleaning surface 61b thereafter, the extraneous matter can be prevented from being entered between the first cleaning surface 61a and the pressing member 65a. If the extraneous matter is entered between the first cleaning surface 61a and the pressing member 65a, cleaning efficiency by the cleaning sheet 61 may be deteriorated due to the extraneous matter or the optical fiber 1a held between the pressing members 65a and 65b may be damaged.

According to the cleaning apparatus 55 having the above configuration, if the case 4 is positioned at the cleaning station S5 by the rotation table 5 and the pressing mechanism 54 presses the cover 30 of the cable holding mechanism 25, the entire cleaning apparatus 55 is elevated by the elevating mechanism 66 and the optical fiber 1a is positioned between the pair of pressing members 65a and 65b.

In this state, the spraying nozzle 67 sprays the cleaning liquid into the cleaning sheet 61 positioned between the pressing members 65a and 65b and then the pressing members 65a and 65b approach each other and hold the optical fiber 1a with the cleaning sheet 61. Thereby, the first cleaning surface 61a and the second cleaning surface 61b of the cleaning sheet 61 contact the optical fiber 1a. In this state, if the elevating mechanism 66 descends the cleaning apparatus 55, an outer circumferential surface of the optical fiber 1a is cleaned by the first and second cleaning surfaces 61a and 61b.

In addition, the cover pressing mechanism 54 presses the cover 30 of the cable holding mechanism 25 while the optical fiber 1a is cleaned, such that the optical fiber cable 1 is not drawn from the case 4.

If the cleaning of the optical fiber 1a is terminated, the pressing members 65a and 65b are separated from each other. Then, the cleaning apparatus 55 is retracted into the lower side of the optical fiber cable 1 by the elevating mechanism 66 and the cover pressing mechanism 54 is separated from the cover 30 of the cable holding mechanism 25.

Furthermore, in the cleaning apparatus 55, the supply roll 62 and the collection roll 63 rotate to feed the cleaning sheet 61 and position the non-used cleaning sheet 61 between the pressing members 65a and 65b. If the cleaning is repeated and the cleaning sheet 61 is fed, the portion of the first cleaning surface 61a having cleaned the optical fiber 1a arrives at the space between the pressing member 65b and the optical fiber 1a.

At this time, in the cleaning sheet 61 of the portion in which one side of the optical fiber 1a has been cleaned by the first cleaning surface 61a, the extraneous matter attached to the first cleaning surface 61a is removed by the scraper 68 during a period until the other side is cleaned by the second cleaning surface 61b. For this reason, the scraps attached to the first cleaning surface 61a are not attached to the optical fiber 1a and the deterioration of the cleaning efficiency or the damage of the optical fiber 1a is prevented from occurring due to the extraneous matter.

As such, according to the cleaning apparatus according to this embodiment, the optical fiber 1a can be cleaned by one cleaning sheet 61 and it not necessary to provide the two cleaning sheets as in related art. Therefore, the optical fiber 1a can be cleaned by a small amount of cleaning sheet 61.

That is, the first cleaning surface 61a and the second cleaning surface 61b of the cleaning sheet 61 are guided by the guide rolls 63a to 63h to face each other with the optical fiber 1a therebetween. For this reason, the first cleaning surface 61a having passed through the optical fiber 1a once does not pass through the optical fiber 1a again and pollutants attached to the first cleaning surface 61a are not attached to the optical fiber 1a again.

Furthermore, the scraper 68 is provided on the path of the cleaning sheet 61 to remove the extraneous matter attached to the first cleaning surface 61a having cleaned the optical fiber 1a, so that the deterioration of the cleaning efficiency or the damage of the optical fiber 1a can be prevented from occurring due to the extraneous matter.

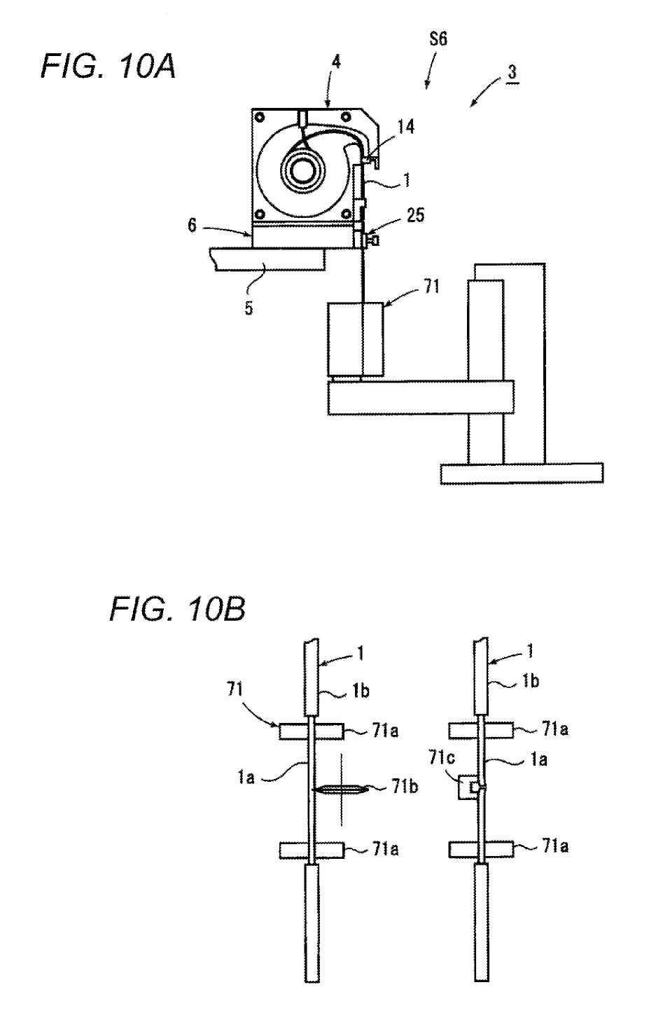

FIG. 10 is a diagram illustrating the cutting station S6. In the cutting station S6, a process for cutting the optical fiber 1a and forming an end face of the optical fiber 1a in a shape in which the optical fiber 1a can be connected to the work 2 is executed.

In the cutting station S6, a cutting mechanism 71 that cuts the optical fiber 1a is provided. As illustrated in FIG. 10(b), the cutting mechanism 71 includes a clamp 71a that holds the upper and lower sides of a cutting position of the optical fiber 1a, a cutter 71b that forms a flaw on an outer circumferential surface of the optical fiber 1a, and a cutting button 71c that presses a surrounding portion of the flaw and fractures the optical fiber 1a.

The cutter 71b moves along the outer circumferential surface of the optical fiber 1a and forms the flaw on the surface of the optical fiber 1a. In this state, if the cutting button 71c presses the surrounding portion of the flaw, the optical fiber 1a is fractured by the development of the crack from the flaw and a necessary end face shape is obtained.

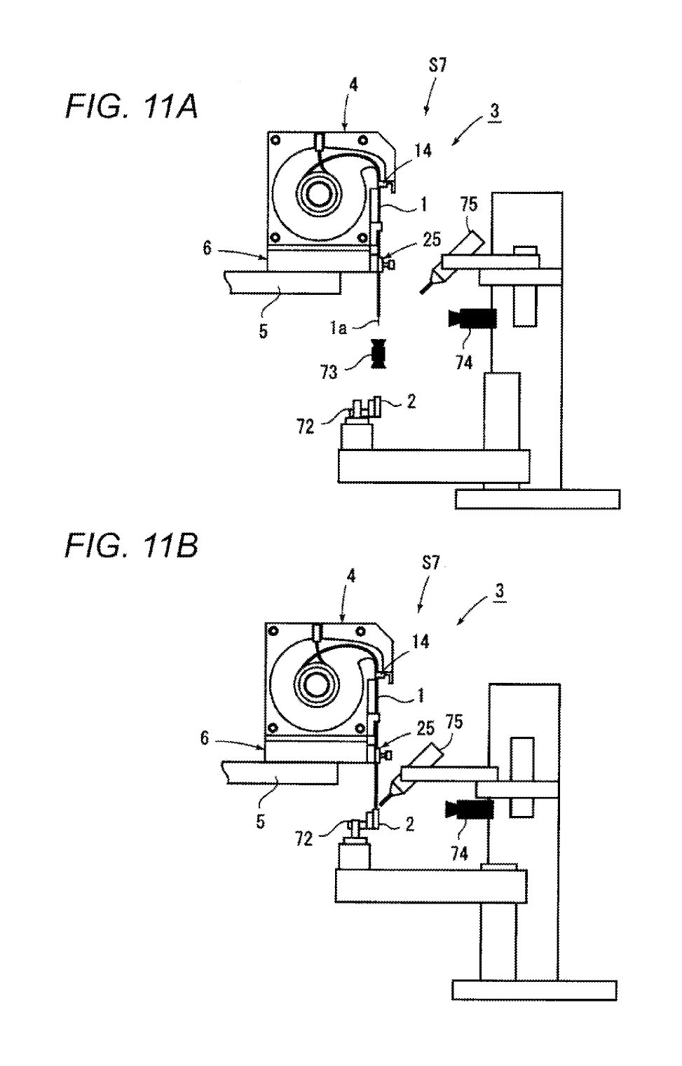

FIG. 11 is a diagram illustrating the mounting station S7. In the mounting station S7, a process for mounting the work 2 on the end face of the cut optical fiber 1a is executed.

The mounting station S7 includes a connector holding mechanism 72 that holds the work 2, first and second cameras 73 and 74 that photograph the end face of the optical fiber 1a and the work 2, and an adhesive supplying mechanism 75 that supplies an adhesive to adhere the optical fiber 1a and the work 2.

The work holding mechanism 72 can hold the work 2 supplied from a work supplying mechanism not illustrated in the drawings, such that a connection portion of the optical fiber 1a faces the upper side, move the work 2 in a horizontal direction and a vertical direction, and rotate the work 2 on a horizontal plane.

If the case 4 is positioned at the mounting station S7, the first camera 73 moves between the optical fiber cable 1 and the work 2 by a moving mechanism not illustrated in the drawings, as illustrated in FIG. 11(a). At the same time, the first camera 73 photographs the vertical direction and photographs a position of the horizontal direction of the end face of the optical fiber 1a and a position of the horizontal direction of a connection portion of the optical fiber in the work 2. The second camera 74 is provided on the side of the optical fiber cable 1 and photographs the height of the end face of the optical fiber 1a and the height of the connection portion of the optical fiber in the work 2 as illustrated in FIG. 11(b).

Images of these first and second cameras 73 and 74 are processed by a control mechanism. Thereby, a relation of the position of the end face of the optical fiber 1a and the position of the connection portion of the optical fiber 1a in the work 2 is recognized.

In addition, the control mechanism elevates the work 2 while moving the work 2 in the horizontal direction by the connector holding mechanism 72, rotates the work 2 on the horizontal plane according to necessity, and positions the connection portion of the optical fiber 1a in the work 2 at the mounting position of the end face of the optical fiber 1a (FIG. 11(b)).

The adhesive supplying mechanism 75 supplies an adhesive such as a thermosetting resin. As illustrated in FIG. 11(b), if the end face of the optical fiber 1a contacts the connection portion of the optical fiber 1a in the work 2, the adhesive supplying mechanism 75 supplies the adhesive to the contact portion to adhere the optical fiber 1a and the work 2.

In this embodiment, because the bending peculiarity of the optical fiber cable 1 is removed in the correcting station S3, the end of the optical fiber 1a faces a portion directly under the optical fiber. The work 2 can be mounted to the optical fiber cable by making the work approach the optical fiber cable from the lower side and a mounting failure is prevented.

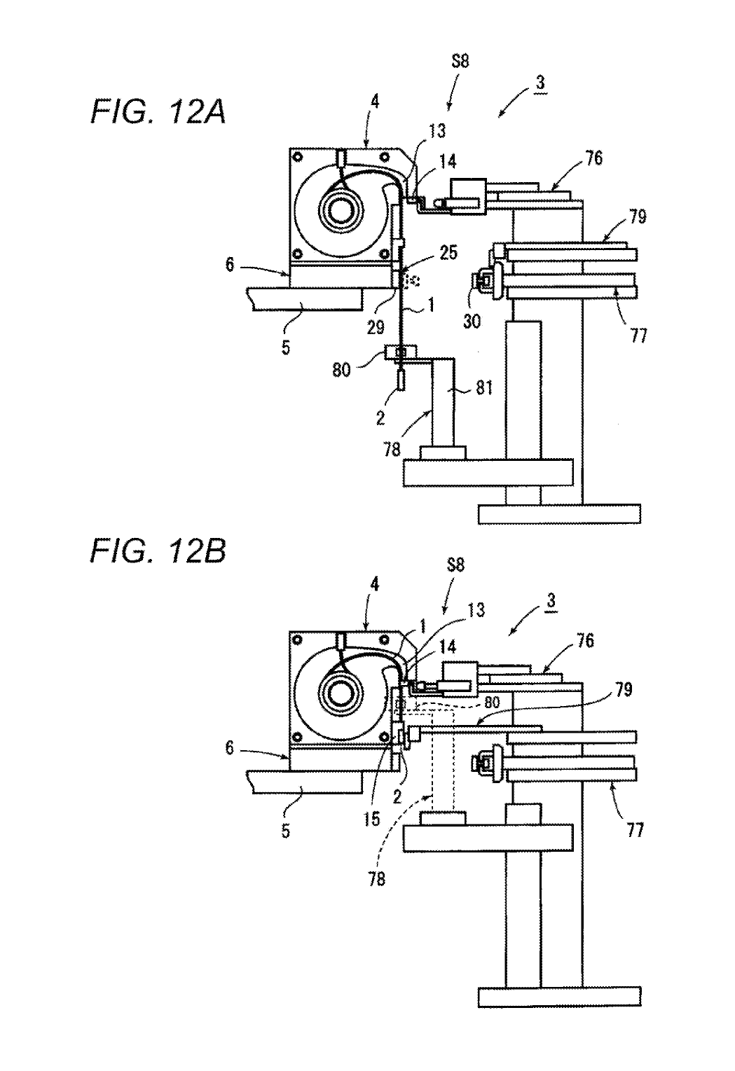

FIG. 12 is a diagram illustrating the returning station S8. In the returning station S8, a process for returning the drawn optical fiber cable 1 to the case 4 and mounting the work 2 to the case 4 is executed.

The returning station S8 includes an opening/closing member moving mechanism 76 that moves the opening/closing member 14 of the case 4, a cover attaching/detaching mechanism 77 that attaches/detaches the cover 30 of the cable holding mechanism 25, a returning mechanism 78 that returns the optical fiber cable 1 to the inner portion of the case 4, and a work mounting guiding mechanism 79 that holds the work 2 by the work holding member 15.

Since the opening/closing member moving mechanism 76 and the cover attaching/detaching mechanism 77 have the configurations common to the opening/closing member moving mechanism 34 and the cover attaching/detaching mechanism 35 of the drawing station S2, detailed explanation thereof is omitted. However, if the case 4 is positioned at the returning station S8, the returning station S8 operates, switches the opening/closing member 14 of the case 4 into an open state, and separates the cover 30 of the cable holding mechanism 25.

The returning mechanism 78 includes a gripper 80 and a moving mechanism 81, similar to the drawing mechanism 36 of the drawing station S2. First, the gripper 80 holds a surrounding portion of a connection portion with the work 2 in the optical fiber cable 1 (FIG. 12(a)).

Next, the moving mechanism 81 elevates the optical fiber cable 1 and moves the work 2 to the front of the work holding member 15 positioned at the lower side of the guide entrance 13a (FIG. 12(b)).

The work mounting guiding mechanism 79 is provided to have the same height as the work holding member 15 of the case 4. If the work 2 rises to the surrounding portion of the work holding member 15, the work mounting guiding mechanism 79 contacts the work 2 and moves the work 2 to the side of the work holding member 15.

That is, if the returning mechanism 78 moves the gripper 80 upward by the moving mechanism 81, the work 2 contacts the work mounting guiding mechanism 79 and is guided by the work mounting guiding mechanism 79 to approach the side of the case and an upper end of the work 2 is fitted into the recess portion 15b of the work holding member 15.

Then, if the opening/closing member 14 is switched into a close state by the opening/closing member moving mechanism 76, the work 2 is held not to be disengaged from the recess portion 15b of the work holding member 15. In addition, the case 4 to which the work 2 has been mounted as described above is conveyed to the feeding/discharging station S1 again by the rotation table 5.

In the feeding/discharging station S1, a lever manipulating mechanism not illustrated in the drawings manipulate the lever 27 of the case holding portion 6 and separates the engagement protrusion 26 of the inserting portion 24 from the protrusion 12a of the core portion 12. Then, the transferring mechanism extracts the case 4 from the case holding portion 6 and places the case 4 on the discharge conveyer 32.

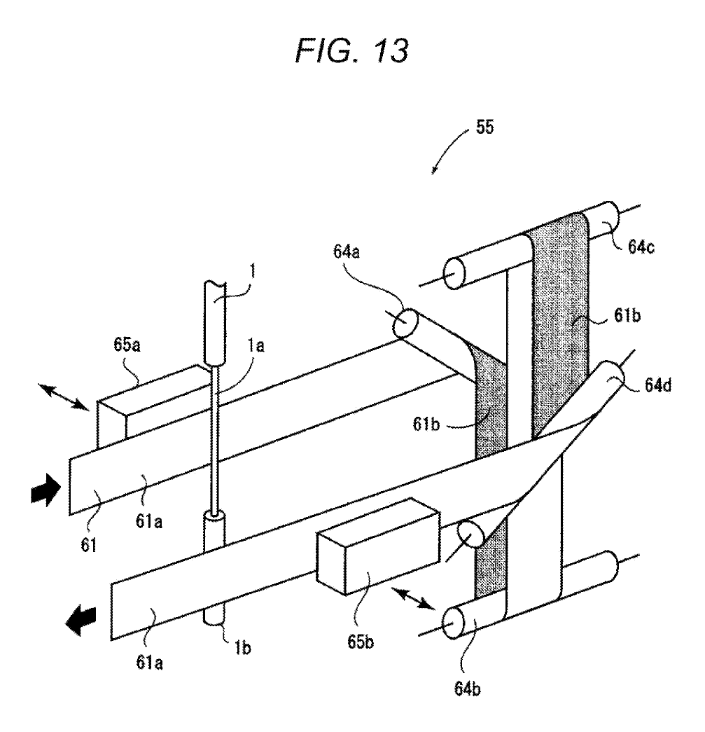

FIG. 13 illustrates a perspective view of a cleaning apparatus 55 of the cleaning station S5 according to a second embodiment. In the following description, explanation of a configuration common to the cleaning apparatus 55 according to the first embodiment is omitted. In addition, in FIG. 13, a white surface of a cleaning sheet 61 is set as a first cleaning surface 61a and a colored surface thereof is set as a second cleaning surface 61b.

Even in this embodiment, only a supply roll and a collection roll (both the supply roll and the collection roll are not illustrated in the drawings) of one set are provided and an optical fiber 1a can be cleaned by one cleaning sheet 61 provided between the supply roll and the collection roll.

In FIG. 13, the supply roll supplies the cleaning sheet 61 from the left side and makes the cleaning sheet 61 pass through a space between a pressing member 65a and the optical fiber 1a. At this time, the first cleaning surface 61a faces the optical fiber 1a.

Meanwhile, the collection roll collects the cleaning sheet 61 to the left side and makes the cleaning sheet makes the cleaning sheet 61 pass through a space between a pressing member 65b and the optical fiber 1a. At this time, the second cleaning surface 61b faces the optical fiber 1a.

That is, even in this embodiment, one cleaning sheet 61 passes through one side and the other side of the optical fiber 1a and the first cleaning surface 61a and the second cleaning surface 61b face each other with the optical fiber 1a therebetween.

As such, because the first cleaning surface 61a and the second cleaning surface 61b of the cleaning sheet 61 face each other with the optical fiber 1a therebetween, in this embodiment, the cleaning sheet 61 is inverted by first to fourth guide rolls 64a to 64d illustrated in FIG. 13.

The first guide roll 64a is provided on the downstream side of a position where the cleaning sheet 61 supplied from the supply roll 62 passes through the optical fiber 1a and is provided at an angle of about 45° with respect to a feed direction of the cleaning sheet 61 to fold the horizontally supplied cleaning sheet 61 downward. In addition, if the cleaning sheet 61 is inverted by the first guide roll 64a, the second cleaning surface 61b faces the cleaning sheet 61 of the side of the collection roll.

The second guide roll 64b is provided to fold the cleaning sheet 61 guided downward by the first guide roll 64a upward. The cleaning sheet 61 is inverted by the second guide roll 63b and the first cleaning surface 61a faces the cleaning sheet 61 of the side of the collection roll.

The third guide roll 64c is provided on the upper side of the first guide roll 64a and is provided to fold the cleaning sheet 61 guided upward by the second guide roll 64b downward. The cleaning sheet 61 is inverted by the third guide roll 64c and the second cleaning surface 61b faces the cleaning sheet 61 of the side of the collection roll.

In addition, the fourth guide roll 64d is provided at an angle of about 45° with respect to a feed direction of the cleaning sheet 61 to fold the cleaning sheet 61 guided downward by the third guide roll 64c in a horizontal direction toward the collection roll.

If the cleaning sheet 61 is inverted by the fourth guide roll 64d, the second cleaning surface 61b is folded to face the optical fiber 1a. As a result, at the position where the optical fiber 1a is cleaned, the first cleaning surface 61a and the second cleaning surface 61b of the cleaning sheet 61 face each other with the optical fiber 1a therebetween.

Since the cleaning sheet 61 is inverted, it is needless to say that arrangements other than the first to fourth guide rolls 64a to 64d illustrated in FIG. 9 can be used.

In addition, similar to the first embodiment, a scraper 68 that removes extraneous matter attached to the first cleaning surface 61a may be provided between a position where the first cleaning surface 61a passes through one side of the optical fiber 1a and a position where the second cleaning surface 61b passes through the other side of the optical fiber 1a.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Optical fiber cable
1a Optical fiber
1b Coating material
2 Work
3 Optical fiber cable processing apparatus
4 Case
5 Rotation table
6 Case holding portion
11 Storage space
12 Core portion
13 Guide space
13a Guide entrance
14 Opening/closing member
23 Support rod
24 Inserting portion
25 Cable holding mechanism
29 Base portion
30 Cover
34 Opening/closing member moving mechanism
35 Cover attaching/detaching mechanism
36 Drawing mechanism
45 Correcting mechanism
55 Cleaning apparatus
61 Cleaning sheet
61a First cleaning surface
61b Second cleaning surface
64a to 64h First to eighth guide rolls
65a, 65b Pressing member
68 Scraper
78 Returning mechanism
79 Work mounting guiding mechanism
S1 Feeding/discharging station
S2 Drawing station
S3 Correcting station
S4 Coating material removing station
S5 Cleaning station
S6 Cutting station
S7 Mounting station
S8 Returning station

What is claimed is:

1. A cleaning apparatus comprising:
a supply roll that supplies a strip-shaped cleaning sheet;
a collection roll that collects the cleaning sheet supplied from the supply roll;
guide rolls that are provided between the supply roll and the collection roll and guide the cleaning sheet; and
a pair of pressing members that are disposed to face each other with a cleaned material therebetween and approach each other or are separated from each other, guides the cleaning sheet by the guide rolls such that the cleaned material is positioned between the cleaning sheet and the cleaning sheet, and cleans the cleaned material by allowing the pressing members to hold the cleaned material with the cleaning sheet,
wherein the supply roll and the collection roll of one set are provided and the cleaned material is cleaned using a first cleaning surface formed on one surface of one cleaning sheet and a second cleaning surface formed on the other surface, and
the guide rolls guide the cleaning sheet, such that the first cleaning surface of the cleaning sheet positioned at one side and the second cleaning surface of the cleaning sheet positioned at the other side face each other with the cleaned material therebetween, and make the cleaning sheet pass through one side and the other side of the cleaned material.

2. The cleaning apparatus according to claim 1,
wherein a removing mechanism that removes extraneous matter attached to one cleaning surface having passed through one side of the cleaned material is provided between a position where one cleaning surface of the first cleaning surface and the second cleaning surface passes through one side of the cleaned material and a position where the other cleaning surface of the first cleaning surface and the second cleaning surface passes through the other side of the cleaned material, on a path of the cleaning sheet.
